(19) United States
(12) Patent Application Publication
(10) Pub. No.: US 2023/0039389 A1
(43) Pub. Date: Feb. 9, 2023

(54) SYSTEMS AND METHODS FOR FACILITATING PREDICTING A FUTURE VALUE OF REAL ESTATE ASSETS

(71) Applicants: Sunder Jagannathan, Coimbatore (IN); Vivek Agarwal, Faridabad (IN); Hitesh Singla, Gurgaon (IN)

(72) Inventors: Sunder Jagannathan, Coimbatore (IN); Vivek Agarwal, Faridabad (IN); Hitesh Singla, Gurgaon (IN)

(73) Assignee: SY Interiors Pvt. Ltd, New Delhi (IN)

(21) Appl. No.: 17/396,675

(22) Filed: Aug. 7, 2021

(51) Int. Cl. G06Q 30/02; G06Q 50/16; G06N 20/00

(52) U.S. Cl. CPC G06Q 30/0278; G06N 20/00; G06Q 30/0283; G06Q 50/16

(57) ABSTRACT

Disclosed herein is a method for facilitating predicting a future value of real estate assets. The method may include receiving at least one real estate asset indication of a real estate asset from at least one user device, identifying an asset location of the real estate asset, retrieving price information of the real estate asset from a distributed ledger, retrieving one or more indexes associated with the asset location from the distributed ledger, analyzing price trend and the one or more indexes, establishing a correlation between the price trend and the one or more indexes, generating the future value for the real estate asset at a future time, transmitting the future value of the real estate asset to the at least one user device and storing one or more datasets to the distributed ledger.

### TECHNICAL FIELD

Generally, the present disclosure relates to the field of data processing. More specifically, the present disclosure relates to methods, systems, apparatuses, and devices for facilitating predicting a future value of real estate assets.

### BACKGROUND

Existing techniques for facilitating predicting a future value of real estate assets are deficient with regard to several aspects. For instance, current technologies do not provide a value of the real estate assets at some future time. Furthermore, current technologies do not predict the future value of the real estate asset based on one or more indexes associated with the real estate asset.

Therefore, there is a need for methods, systems, apparatuses, and devices for facilitating predicting a future value of real estate assets that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

Disclosed herein is a method for facilitating predicting a future value of real estate assets, in accordance with some embodiments. The method may include a step of receiving, using a communication device, at least one real estate asset indication of a real estate asset from at least one user device. Further, the method may include a step of identifying, using a processing device, an asset location of the real estate asset based on the at least one real estate asset indication. Further, the method may include a step of retrieving, using a storage device, price information of the real estate asset from a distributed ledger based on the identifying. Further, the price information may include a price trend of a price of the real estate asset. Further, the method may include a step of retrieving, using the storage device, one or more indexes associated with the asset location from the distributed ledger based on the identifying. Further, the price corresponds to the one or more indexes. Further, the one or more indexes may include a livability index, a commercial proximity index, a lifestyle index, and a value-for-money index. Further, the method may include a step of analyzing, using the processing device, the price trend and the one or more indexes based on at least one machine learning model. Further, the method may include a step of establishing, using the processing device, a correlation between the price trend and the one or more indexes based on the analyzing. Further, the method may include a step of generating, using the processing device, the future value for the real estate asset at a future time based on the correlation, the price trend, and the one or more indexes. Further, the method may include a step of transmitting, using the communication device, the future value of the real estate asset to the at least one user device. Further, the method may include a step of storing, using the storage device, one or more datasets to the distributed ledger. Further, the one or more datasets may include one or more the one or more indexes and the price information.

Further disclosed herein is a system of facilitating predicting a future value of real estate assets, in accordance with some embodiments. The system may include a communication device, a processing device, and a storage device. Further, the communication device may be configured for performing a step of receiving at least one real estate asset indication of a real estate asset from at least one user device. Further, the communication device may be configured for performing a step of transmitting the future value of the real estate asset to the at least one user device. Further, the processing device may be communicatively coupled with the communication device. Further, the processing device may be configured for performing a step of identifying an asset location of the real estate asset based on the at least one real estate asset indication. Further, the processing device may be configured for performing a step of analyzing a price trend and one or more indexes based on at least one machine learning model. Further, the processing device may be configured for performing a step of establishing a correlation between the price trend and the one or more indexes based on the analyzing. Further, the processing device may be configured for performing a step of generating the future value for the real estate asset at a future time based on the correlation, the price trend, and the one or more indexes. Further, the storage device may be communicatively coupled with the processing device. Further, the storage device may be configured for performing a step of retrieving price information of the real estate asset from a distributed ledger based on the identifying. Further, the price information may include the price trend of a price of the real estate asset. Further, the storage device may be configured for performing a step of retrieving the one or more indexes associated with the asset location from the distributed ledger based on the identifying. Further, the price corresponds to the one or more indexes. Further, the one or more indexes may include a livability index, a commercial proximity index, a lifestyle index, and a value-for-money index. Further, the storage device may be configured for performing a step of storing one or more datasets to the distributed ledger. Further, the one or more datasets may include one or more of the one or more indexes and the price information.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating predicting a future value of real estate assets, in accordance with some embodiments.

FIG. 4 is a continuation flow chart of FIG. 3.

FIG. 5 is a flow chart of a method for facilitating predicting a future value of real estate assets, in accordance with some embodiments.

FIG. 6 is a flow chart of a method for facilitating predicting a future value of real estate assets, in accordance with some embodiments.

FIG. 7 is a flow chart of a method for facilitating predicting a future value of real estate assets, in accordance with some embodiments.

FIG. 8 is a flow chart of a method for facilitating predicting a future value of real estate assets, in accordance with some embodiments.

FIG. 9 is a continuation flow chart of FIG. 8.

FIG. 10 is a flow chart of a method for facilitating predicting a future value of real estate assets, in accordance with some embodiments.

FIG. 11 is a flow chart of a method for facilitating predicting a future value of real estate assets, in accordance with some embodiments.

FIG. 12 is a block diagram of a system for facilitating predicting a future value of real estate assets, in accordance with some embodiments.

FIG. 13 is a schematic diagram of an area map of an area associated with a real estate asset, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating predicting a future value of real estate assets, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Definitions

The future value may refer to a future price of the real estate asset.

The real estate asset may include a property. Further, the property may be comprised of a land and a structure built on the land. Further, the real estate asset may include a plot of land, a building, an apartment, etc.

The at least one real estate asset indication may include an asset identifier. Further, the asset identifier may include a name of the real estate asset.

The asset location may refer a geographical location on the earth.

The livability index may be a measure of the suitability for living in the real estate asset. Further, the commercial proximity index may be a measure of closeness to at least one commercial establishment. Further, the lifestyle index may be a measure of availableness of at least one facility in the asset location. Further, the value-for-money index is a measure of a worthiness of the real estate asset in terms of a value of the real estate asset.

The at least one environmental quality index may be a measure of hospitability of the environment. Further, the at least one environmental quality index may include at least one of an air quality index, a water quality index, a soil quality index, an electromagnetic radiation index, an ultraviolet index, a precipitation index, a tornado index, a flood vulnerability index, an earthquake vulnerability index, a wind index, and a noise pollution index

The environmental condition may include a temperature, a precipitation, an insolation, a wind, a humidity, a radiation, etc. Further, the environment medium may include air, water, soil, etc.

The at least one government entity device may include the asset information.

The at least one government entity may be tasked with managing the real estate assets.

The dispute may include a land dispute, a legal dispute, etc. Further, the dispute may be associated with the real estate asset. Further, the dispute may be associated with the at least one developer.

The area may refer to a geographical area on the earth. Further, the area may include a city, a town, a village, a county, a state, a country, etc.

The one or more hotspots may include a bar, a restaurant, a mall, a hotel, a motel, a hang-out place, an arcade, a gym, etc. Further, the one or more hotspots may include one or more establishments that may frequently be visited by people.

The at least social media metric may include rating, check-in, occupancy, endorsement, review, etc. of the one or more hotspots.

The one or more metric values may be a score given against the at least one social media metric for the one or more hotspots.

The one or more commercial establishments may a place for conducting commercial activities.

The asset location data may include facilities that may be available at the asset location.

The at least one facility may include an amenity, a luxury, a service, a specification, etc.

### Overview

The present disclosure describes methods, systems, apparatuses, and devices for facilitating predicting a future value of real estate assets. Further, the present disclosure describes calculating the future value of a real estate property from multiple indices and showing a user a personalized view. Calculating the future value and showing the user the personalized view may require:
1. Land information
2. History of prices
3. Air quality index
4. Calculating indices for real estate - Liveability, Connectivity, Lifestyle, value for money

Further, the Liveability Index defines how much the particular project is liveable in comparison to other projects of a given city. For calculating this index, we leverage Facebook places data, where a category of a place like a restaurant, a bar, a hotel, a hang-out place, a gym, etc. defined along with a number of people doing check-ins, liking the given place, rating those places. We assume that the more the number and popular places near a given location, the more is the probability of that location being liveable as people must be flocking to those locations. We consider 5 Km crow distance as the boundary condition if the particular project is in influence or direct impact of the place. We computed a gross score for each project based on our algorithm with a certain weightage to check-in, likes, rating, etc., and gradually decrease the score if the distance increases from a given project location. For e.g. Place-A with a certain rating, check-in, likes will impact Project-X differently than Project-Y if the distance between A-X and A-Y is different. Once we have a gross score for each location, we tried to find an outlier from the population based on bell curve norms where anything away of mean -3 Standard deviation and mean +3 standard deviation is considered an outlier. Once we have a normalized score after correcting the outlier, we index all projects of a given city between 5 to 10 based on their score in respect to the maximum. The Highest Normalized score will be awarded 10 and the lowest 5, all others will fall in between based on the actual normalized score. Datasets that show sentimental analysis from reviews of that area.

Further, the Commercial proximity defines how much the particular project is closer to a chief business district (CBD) of a particular city. Every city usually has multiple places where office places or commercial establishments present, so we identified all such CBDs of a given city as well the average rentals of that CBD. Based on this data, we calculated the distance of each CBD from a given project and then calculated a weighted score (inversely proportional to distance) of each project based on a weightage of the given CBD. Like CBD commanding 200 Rs. per sq. ft. rental will have high weightage for even same distance than a place with 100 Rs. per sq. ft. rental CBD. We defined a certain boundary distance (15 Km) till which that particular CBD impact the given project, once we have a weighted score for each project, we corrected outliers and calculated an index between 5-10.

Further, the Connectivity Index defines how much the given project is connected in terms of physical infrastructure present in a city whether it be road network, railways, metro, airport, monorail, etc. We physically mapped the complete city and find out all major roads of the city, the railway stations, the airport, the metro stations, etc. Polylines for each road were created at an average distance of 1-2 Km which would act as a connecting point to a given road. We also leveraged rental data of all business districts of a particular city to find out the importance of a given road for particular city connectivity. Like one road which is closer to the major CBD will have better weightage than the one which is there around the upcoming CBD where rentals are less and very less commercial establishments are working. We define weightage to each infrastructure element of the city like the metro, the railways, the roads, etc. depending on which city relies more on that particular infrastructure like Locals of Mumbai will have higher weightage compare to locals in other locations, etc. Once weightage is finalized for each element like Road-1, road-2 railway-1, metro-1, etc., gross distance is calculated for each project based on weightage. This data is subjected to outlier norms and normalized to arrive at a final score. Based on these values, an indexation between 5-10 is done.

All above described indices were focusing on the location of the project in terms of whether it is liveable from the surrounding, connected for outside mobility, and closeness to a workplace but a Lifestyle Index actually defines the level of amenities, luxuries, services, specifications offered inside in the compound of project. For calculating the Lifestyle Index, all items have been given certain weightage based on their importance & luxury quotient like VRV AC will have more points than regular split AC or no built in AC, similarly, flooring, green area, number of sports offered including golf, helipad, etc. For calculating this index, each project point is calculated under 5 heads - Outdoor, Green, Convenience, Amenities, and Club House. Total points of each project under different heads were subjected to an outlier check for a given city and outlier normalized to the base score. The score under each head is cumulated to arrive at a total project score which is further indexed in a range of 5-10 based on overall value. We also leveraged a score under each head for a given project to compute star rating which is published in our CMA report. Bell curve methodology followed to give star points in terms of a number of deviations away from an average number in the range of 1-5 star rating.

Further, the Value for Money defines the worthiness of a project in terms of a price offered against connectivity, workplace proximity, livability at a given location along with amenities/specifications provided in a given project compound. Data related to pricing, construction stage of the project, etc. used to arrive at an effective value of the project as project recently launched will have less effective value as payment need to be staggered in next 2-3 years in comparison to ready to move or well occupied properties. All above calculated index leverage along with the effective price to arrive at a value for money (Investment score in CMA).

Datasets that show sentimental analysis from reviews of that area. Datasets that we can use:
Transaction History of nearby properties
Datasets that show sentimental analysis from reviews of that area
Datasets that show transaction frequency of the properties in the defined area
Datasets showing price growth of the defined area from government documents
Datasets showing upcoming developments in that area
Datasets showing past history of the builder and his completion rate %, brand value
Datasets for rental income

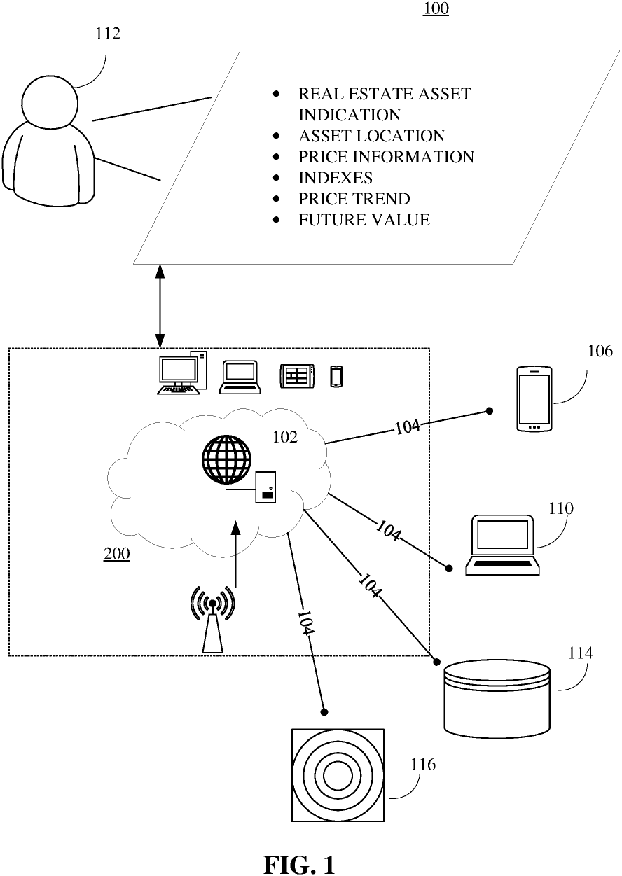

FIG. 1 is an illustration of an online platform 100 consistent with various embodiments of the present disclosure. By way of non-limiting example, the online platform 100 to enable facilitating predicting a future value of real estate assets may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

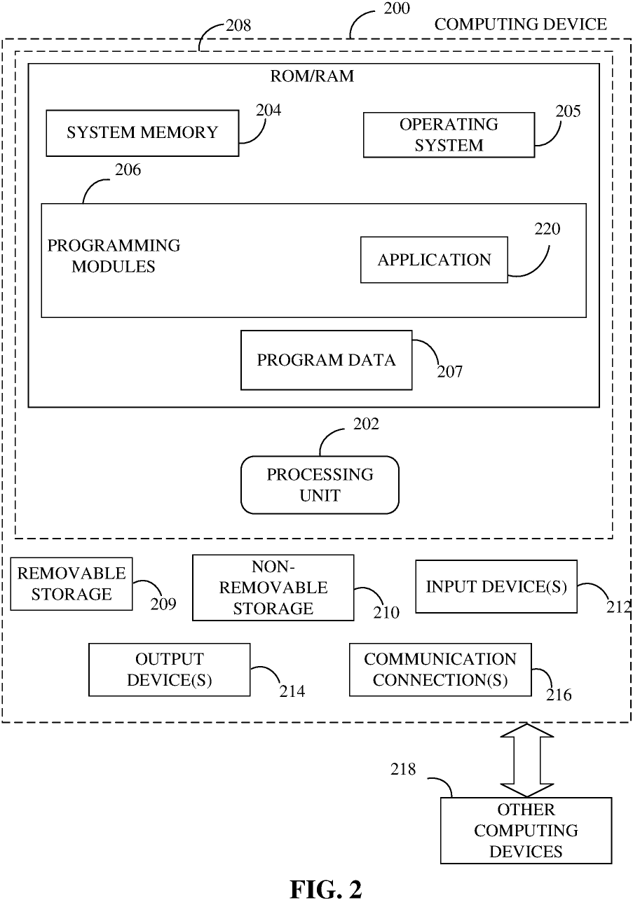

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

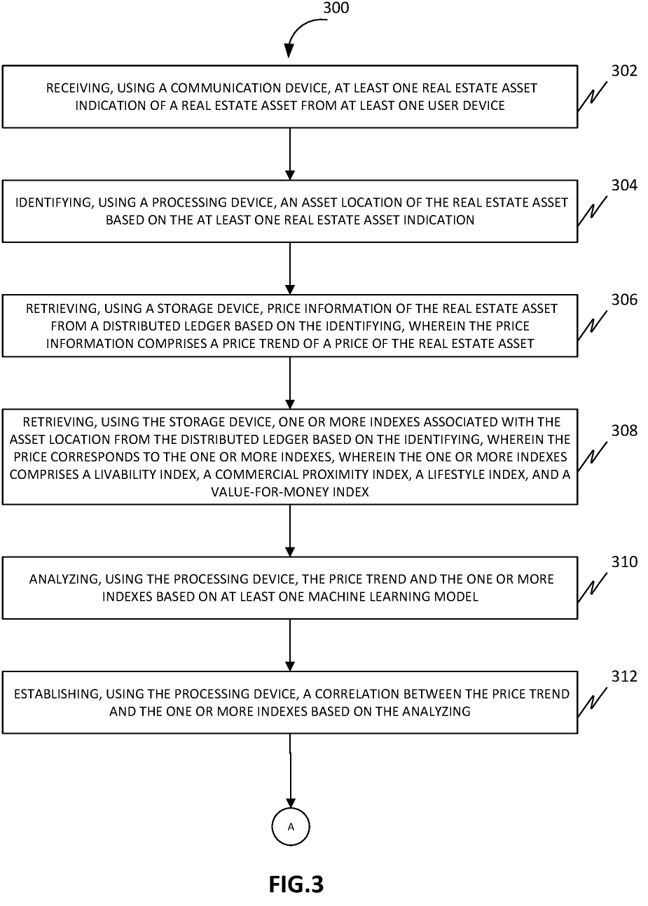

FIG. 3 is a flow chart of a method 300 for facilitating predicting a future value of real estate assets, in accordance with some embodiments.

Further, at 302, the method 300 may include receiving, using a communication device, at least one real estate asset indication of a real estate asset from at least one user device.

Further, at 304, the method 300 may include identifying, using a processing device, an asset location of the real estate asset based on the at least one real estate asset indication.

Further, at 306, the method 300 may include retrieving, using a storage device, price information of the real estate asset from a distributed ledger based on the identifying. Further, the price information may include a price trend of a price of the real estate asset.

Further, at 308, the method 300 may include retrieving, using the storage device, one or more indexes associated with the asset location from the distributed ledger based on the identifying. Further, the price corresponds to the one or more indexes. Further, the one or more indexes may include a livability index, a commercial proximity index, a lifestyle index, and a value-for-money index.

Further, at 310, the method 300 may include analyzing, using the processing device, the price trend and the one or more indexes based on at least one machine learning model.

Further, at 312, the method 300 may include establishing, using the processing device, a correlation between the price trend and the one or more indexes based on the analyzing.

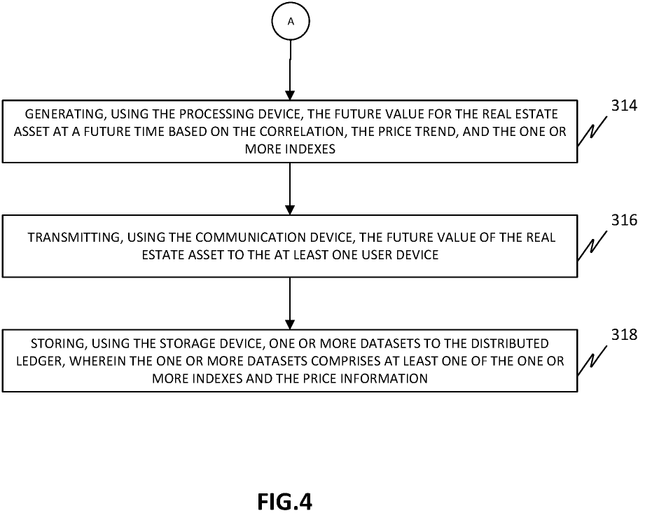

FIG. 4 is a continuation flow chart of FIG. 3.

Further, at 314, the method 300 may include generating, using the processing device, the future value for the real estate asset at a future time based on the correlation, the price trend, and the one or more indexes.

Further, at 316, the method 300 may include transmitting, using the communication device, the future value of the real estate asset to the at least one user device.

Further, at 318, the method 300 may include storing, using the storage device, one or more datasets to the distributed ledger. Further, the one or more datasets may include at least one of the one or more indexes and the price information.

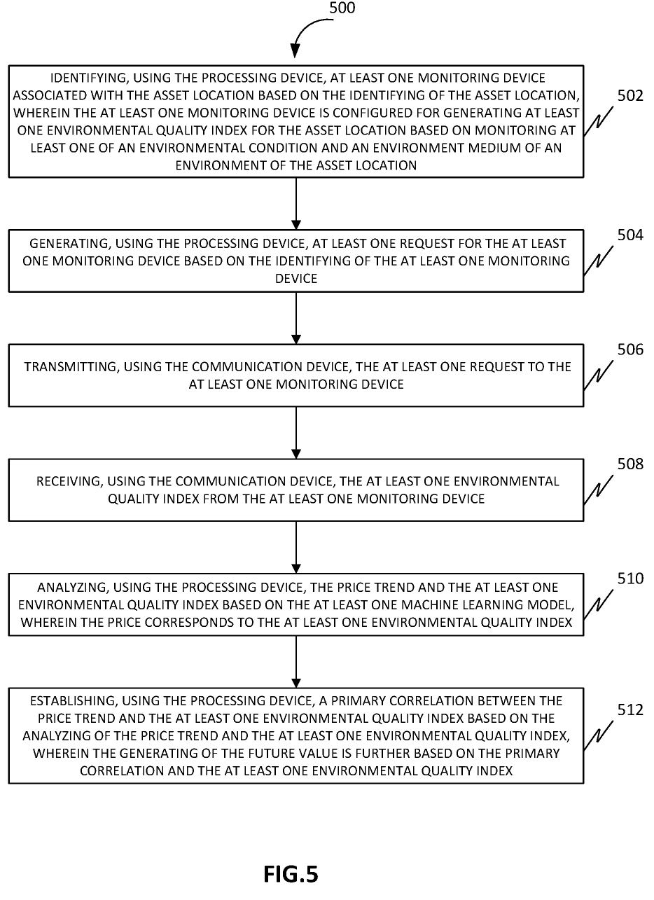

FIG. 5 is a flow chart of a method 500 for facilitating predicting a future value of real estate assets, in accordance with some embodiments.

Further, at 502, the method 500 may include identifying, using the processing device, at least one monitoring device associated with the asset location based on the identifying of the asset location. Further, the at least one monitoring device may be configured for generating at least one environmental quality index for the asset location based on monitoring at least one of an environmental condition and an environment medium of an environment of the asset location.

Further, at 504, the method 500 may include generating, using the processing device, at least one request for the at least one monitoring device based on the identifying of the at least one monitoring device.

Further, at 506, the method 500 may include transmitting, using the communication device, the at least one request to the at least one monitoring device.

Further, at 508, the method 500 may include receiving, using the communication device, the at least one environmental quality index from the at least one monitoring device.

Further, at 510, the method 500 may include analyzing, using the processing device, the price trend and the at least one environmental quality index based on the at least one machine learning model. Further, the price corresponds to the at least one environmental quality index.

Further, at 512, the method 500 may include establishing, using the processing device, a primary correlation between the price trend and the at least one environmental quality index based on the analyzing of the price trend and the at least one environmental quality index. Further, the generating of the future value may be based on the primary correlation and the at least one environmental quality index.

In some embodiments, the at least one monitoring device may include at least one vehicular monitoring device traversing the asset location. Further, the monitoring of one or more of the environmental condition and the environment medium of the environment of the asset location may be based on the traversing.

In some embodiments, the at least one monitoring device may include at least one satellite orbiting over the asset location. Further, the monitoring of one or more of the environmental condition and the environment medium of the environment of the asset location may be based on the orbiting.

In some embodiments, the at least one monitoring device may include at least one aerial monitoring device suspending over the asset location. Further, the monitoring of one or more of the environmental condition and the environment medium of the environment of the asset location may be based on the suspending.

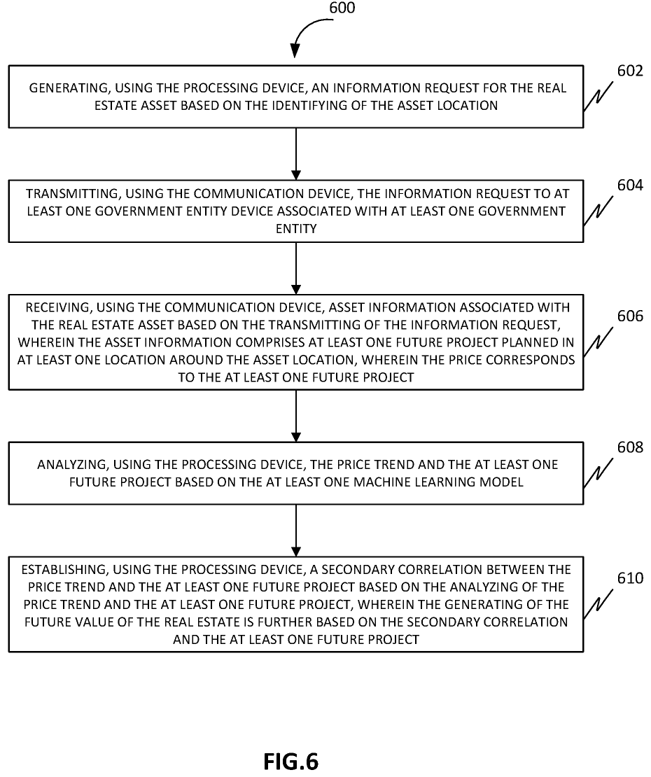

FIG. 6 is a flow chart of a method 600 for facilitating predicting a future value of real estate assets, in accordance with some embodiments.

Further, at 602, the method 600 may include generating, using the processing device, an information request for the real estate asset based on the identifying of the asset location.

Further, at 604, the method 600 may include transmitting, using the communication device, the information request to at least one government entity device associated with at least one government entity.

Further, at 606, the method 600 may include receiving, using the communication device, asset information associated with the real estate asset based on the transmitting of the information request. Further, the asset information may include at least one future project planned in at least one location around the asset location. Further, the price corresponds to the at least one future project.

Further, at 608, the method 600 may include analyzing, using the processing device, the price trend and the at least one future project based on the at least one machine learning model.

Further, at 610, the method 600 may include establishing, using the processing device, a secondary correlation between the price trend and the at least one future project based on the analyzing of the price trend and the at least one future project. Further, the generating of the future value of the real estate may be based on the secondary correlation and the at least one future project.

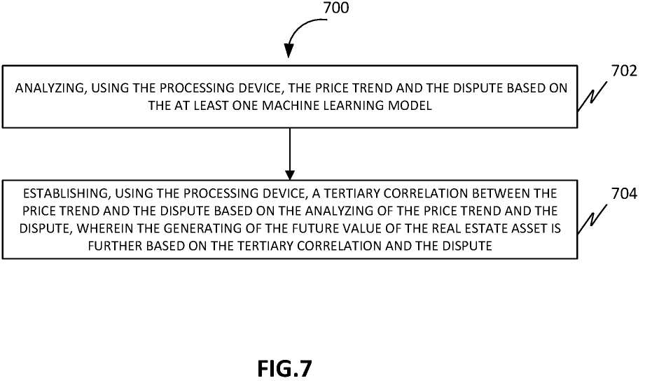

FIG. 7 is a flow chart of a method 700 for facilitating predicting a future value of real estate assets, in accordance with some embodiments. The asset information may further include a dispute associated with the real estate asset. Further, the dispute may be in connection with at least one of the real estate asset and at least one developer developing the real estate asset. Further, the price corresponds to the dispute.

Further, at 702, the method 700 may include analyzing, using the processing device, the price trend and the dispute based on the at least one machine learning model.

Further, at 704, the method 700 may include establishing, using the processing device, a tertiary correlation between the price trend and the dispute based on the analyzing of the price trend and the dispute. Further, the generating of the future value of the real estate asset may be based on the tertiary correlation and the dispute.

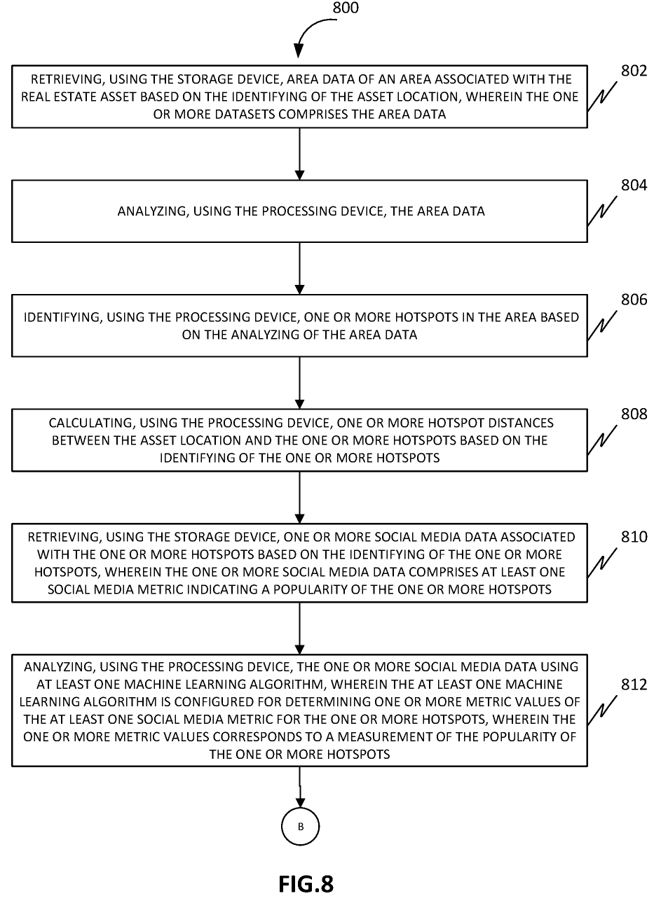

FIG. 8 is a flow chart of a method 800 for facilitating predicting a future value of real estate assets, in accordance with some embodiments.

Further, at 802, the method 800 may include retrieving, using the storage device, area data of an area associated with the real estate asset based on the identifying of the asset location. Further, the one or more datasets may include the area data.

Further, at 804, the method 800 may include analyzing, using the processing device, the area data.

Further, at 806, the method 800 may include identifying, using the processing device, one or more hotspots in the area based on the analyzing of the area data.

Further, at 808, the method 800 may include calculating, using the processing device, one or more hotspot distances between the asset location and the one or more hotspots based on the identifying of the one or more hotspots.

Further, at 810, the method 800 may include retrieving, using the storage device, one or more social media data associated with the one or more hotspots based on the identifying of the one or more hotspots. Further, the one or more social media data may include at least one social media metric indicating a popularity of the one or more hotspots.

Further, at 812, the method 800 may include analyzing, using the processing device, the one or more social media data using at least one machine learning algorithm. Further, the at least one machine learning algorithm may be configured for determining one or more metric values of the at least one social media metric for the one or more hotspots. Further, the one or more metric values corresponds to a measurement of the popularity of the one or more hotspots.

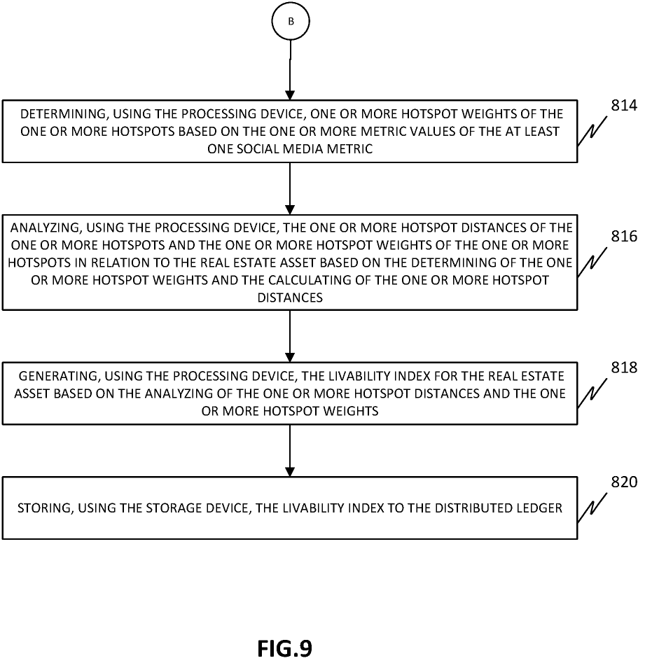

FIG. 9 is a continuation flow chart of FIG. 8.

Further, at 814, the method 800 may include determining, using the processing device, one or more hotspot weights of the one or more hotspots based on the one or more metric values of the at least one social media metric.

Further, at 816, the method 800 may include analyzing, using the processing device, the one or more hotspot distances of the one or more hotspots and the one or more hotspot weights of the one or more hotspots in relation to the real estate asset based on the determining of the one or more hotspot weights and the calculating of the one or more hotspot distances.

Further, at 818, the method 800 may include generating, using the processing device, the livability index for the real estate asset based on the analyzing of the one or more hotspot distances and the one or more hotspot weights.

Further, at 820, the method 800 may include storing, using the storage device, the livability index to the distributed ledger.

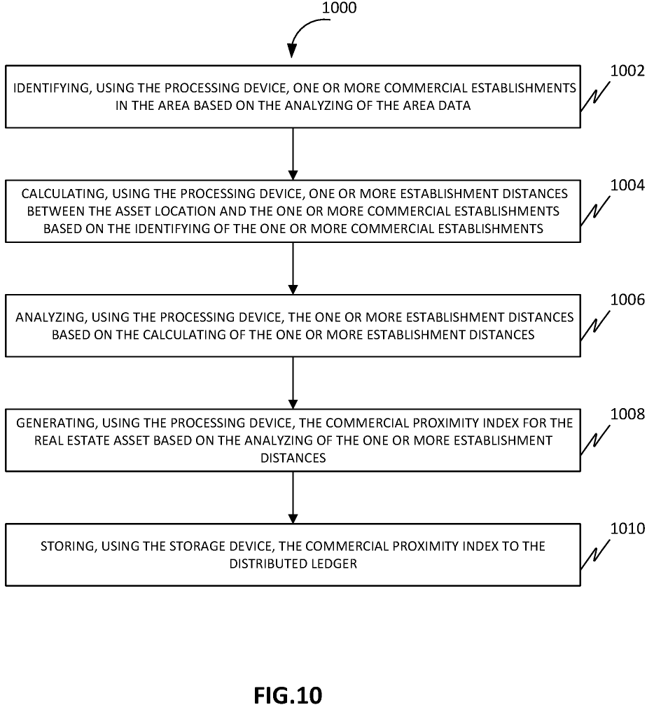

FIG. 10 is a flow chart of a method 1000 for facilitating predicting a future value of real estate assets, in accordance with some embodiments.

Further, at 1002, the method 1000 may include identifying, using the processing device, one or more commercial establishments in the area based on the analyzing of the area data.

Further, at 1004, the method 1000 may include calculating, using the processing device, one or more establishment distances between the asset location and the one or more commercial establishments based on the identifying of the one or more commercial establishments.

Further, at 1006, the method 1000 may include analyzing, using the processing device, the one or more establishment distances based on the calculating of the one or more establishment distances.

Further, at 1008, the method 1000 may include generating, using the processing device, the commercial proximity index for the real estate asset based on the analyzing of the one or more establishment distances.

Further, at 1010, the method 1000 may include storing, using the storage device, the commercial proximity index to the distributed ledger.

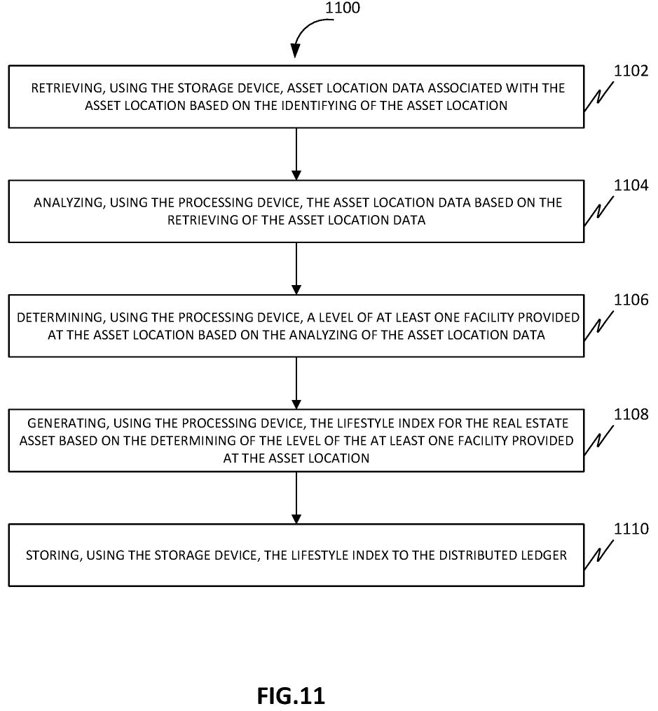

FIG. 11 is a flow chart of a method 1100 for facilitating predicting a future value of real estate assets, in accordance with some embodiments.

Further, at 1102, the method 1100 may include retrieving, using the storage device, asset location data associated with the asset location based on the identifying of the asset location.

Further, at 1104, the method 1100 may include analyzing, using the processing device, the asset location data based on the retrieving of the asset location data.

Further, at 1106, the method 1100 may include determining, using the processing device, a level of at least one facility provided at the asset location based on the analyzing of the asset location data.

Further, at 1108, the method 1100 may include generating, using the processing device, the lifestyle index for the real estate asset based on the determining of the level of the at least one facility provided at the asset location.

Further, at 1110, the method 1100 may include storing, using the storage device, the lifestyle index to the distributed ledger.

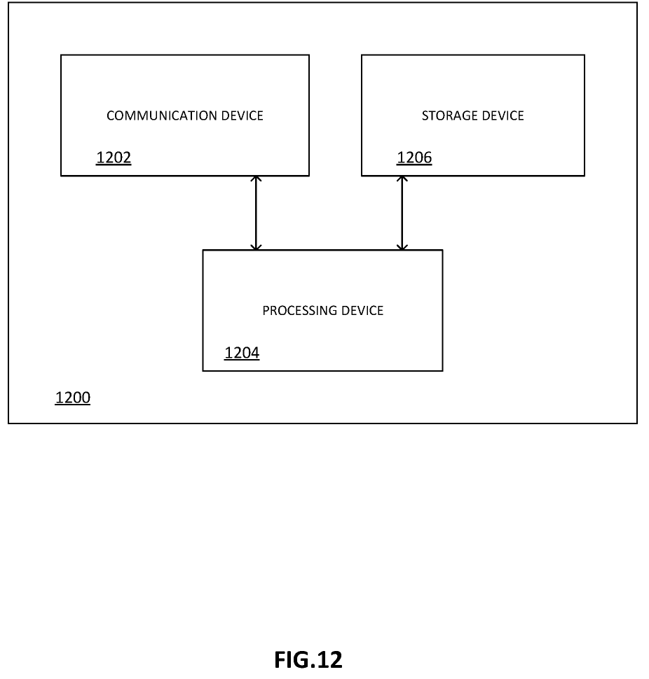

FIG. 12 is a block diagram of a system 1200 for facilitating predicting a future value of real estate assets, in accordance with some embodiments. The system 1200 may include a communication device 1202, a processing device 1204, and a storage device 1206.

Further, the communication device 1202 may be configured for performing a step of receiving at least one real estate asset indication of a real estate asset from at least one user device.

Further, the communication device 1202 may be configured for performing a step of transmitting the future value of the real estate asset to the at least one user device.

Further, the processing device 1204 may be communicatively coupled with the communication device 1202.

Further, the processing device 1204 may be configured for performing a step of identifying an asset location of the real estate asset based on the at least one real estate asset indication.

Further, the processing device 1204 may be configured for performing a step of analyzing a price trend and one or more indexes based on at least one machine learning model.

Further, the processing device 1204 may be configured for performing a step of establishing a correlation between the price trend and the one or more indexes based on the analyzing.

Further, the processing device 1204 may be configured for performing a step of generating the future value for the real estate asset at a future time based on the correlation, the price trend, and the one or more indexes.

Further, the storage device 1206 may be communicatively coupled with the processing device 1204.

Further, the storage device 1206 may be configured for performing a step of retrieving price information of the real estate asset from a distributed ledger based on the identifying. Further, the price information may include the price trend of a price of the real estate asset.

Further, the storage device 1206 may be configured for performing a step of retrieving the one or more indexes associated with the asset location from the distributed ledger based on the identifying. Further, the price corresponds to the one or more indexes. Further, the one or more indexes may include a livability index, a commercial proximity index, a lifestyle index, and a value-for-money index.

Further, the storage device 1206 may be configured for performing a step of storing one or more datasets to the distributed ledger. Further, the one or more datasets may include one or more of the one or more indexes and the price information.

In some embodiments, the processing device 1204 may be configured for performing a step of identifying at least one monitoring device associated with the asset location based on the identifying of the asset location. Further, the at least one monitoring device may be configured for generating at least one environmental quality index for the asset location based on monitoring one or more of an environmental condition and an environment medium of an environment of the asset location.

Further, the processing device 1204 may be configured for performing a step of generating at least one request for the at least one monitoring device based on the identifying of the at least one monitoring device.

Further, the processing device 1204 may be configured for performing a step of analyzing the price trend and the at least one environmental quality index based on the at least one machine learning model. Further, the price corresponds to the at least one environmental quality index.

Further, the processing device 1204 may be configured for performing a step of establishing a primary correlation between the price trend and the at least one environmental quality index based on the analyzing of the price trend and the at least one environmental quality index. Further, the generating of the future value may be based on the primary correlation and the at least one environmental quality index.

Further, the communication device 1202 may be configured for performing a step of transmitting the at least one request to the at least one monitoring device.

Further, the communication device 1202 may be configured for performing a step of receiving the at least one environmental quality index from the at least one monitoring device.

In some embodiments, the at least one monitoring device may include at least one vehicular monitoring device traversing the asset location. Further, the monitoring of one or more of the environmental condition and the environment medium of the environment of the asset location may be based on the traversing.

In some embodiments, the at least one monitoring device may include at least one satellite orbiting over the asset location. Further, the monitoring of one or more of the environmental condition and the environment medium of the environment of the asset location may be based on the orbiting.

In some embodiments, the at least one monitoring device may include at least one aerial monitoring device suspending over the asset location. Further, the monitoring of one or more of the environmental condition and the environment medium of the environment of the asset location may be based on the suspending.

In some embodiments, the processing device 1204 may be configured for performing a step of generating an information request for the real estate asset based on the identifying of the asset location.

Further, the processing device 1204 may be configured for performing a step of analyzing the price trend and at least one future project based on the at least one machine learning model.

Further, the processing device 1204 may be configured for performing a step of establishing a secondary correlation between the price trend and the at least one future project based on the analyzing of the price trend and the at least one future project. Further, the generating of the future value of the real estate may be based on the secondary correlation and the at least one future project.

Further, the communication device 1202 may be configured for performing a step of transmitting the information request to at least one government entity device associated with at least one government entity.

Further, the communication device 1202 may be configured for performing a step of receiving asset information associated with the real estate asset based on the transmitting of the information request. Further, the asset information may include the at least one future project planned in at least one location around the asset location. Further, the price corresponds to the at least one future project.

In some embodiments, the asset information may include a dispute associated with the real estate asset. Further, the dispute may be in connection with at least one of the real estate asset and at least one developer developing the real estate asset. Further, the price corresponds to the dispute.

Further, the processing device 1204 may be configured for performing a step of analyzing the price trend and the dispute based on the at least one machine learning model.

Further, the processing device 1204 may be configured for performing a step of establishing a tertiary correlation between the price trend and the dispute based on the analyzing of the price trend and the dispute. Further, the generating of the future value of the real estate asset may be based on the tertiary correlation and the dispute.

In some embodiments, the storage device 1206 may be configured for performing a step of retrieving area data of an area associated with the real estate asset based on the identifying of the asset location. Further, the one or more datasets may include the area data.

Further, the storage device 1206 may be configured for performing a step of retrieving one or more social media data associated with one or more hotspots based on the identifying of the one or more hotspots. Further, the one or more social media data may include at least one social media metric indicating a popularity of the one or more hotspots.

Further, the storage device 1206 may be configured for performing a step of storing the livability index to the distributed ledger.

Further, the processing device 1204 may be configured for performing a step of analyzing the area data.

Further, the processing device 1204 may be configured for performing a step of identifying the one or more hotspots in the area based on the analyzing of the area data.

Further, the processing device 1204 may be configured for performing a step of calculating one or more hotspot distances between the asset location and the one or more hotspots based on the identifying of the one or more hotspots.

Further, the processing device 1204 may be configured for performing a step of analyzing the one or more social media data using at least one machine learning algorithm. Further, the at least one machine learning algorithm may be configured for performing a step of determining one or more metric values of the at least one social media metric for the one or more hotspots. Further, the one or more metric values corresponds to a measurement of the popularity of the one or more hotspots.

Further, the processing device 1204 may be configured for performing a step of determining one or more hotspot weights of the one or more hotspots based on the one or more metric values of the at least one social media metric.

Further, the processing device 1204 may be configured for performing a step of analyzing the one or more hotspot distances of the one or more hotspots and the one or more hotspot weights of the one or more hotspots in relation to the real estate asset based on the determining of the one or more hotspot weights and the calculating of the one or more hotspot distances.

Further, the processing device 1204 may be configured for performing a step of generating the livability index for the real estate asset based on the analyzing of the one or more hotspot distances and the one or more hotspot weights.

In some embodiments, the processing device 1204 may be configured for performing a step of identifying one or more commercial establishments in the area based on the analyzing of the area data.

Further, the processing device 1204 may be configured for performing a step of calculating one or more establishment distances between the asset location and the one or more commercial establishments based on the identifying of the one or more commercial establishments.

Further, the processing device 1204 may be configured for performing a step of analyzing the one or more establishment distances based on the calculating of the one or more establishment distances.

Further, the processing device 1204 may be configured for performing a step of generating the commercial proximity index for the real estate asset based on the analyzing of the one or more establishment distances. Further, the storage device 1206 may be configured for performing a step of storing the commercial proximity index to the distributed ledger.

In some embodiments, the storage device 1206 may be configured for performing a step of retrieving asset location data associated with the asset location based on the identifying of the asset location. Further, the storage device 1206 may be configured for performing a step of storing the lifestyle index to the distributed ledger. Further, the processing device 1204 may be configured for performing a step of analyzing the asset location data based on the retrieving of the asset location data. Further, the processing device 1204 may be configured for performing a step of determining a level of at least one facility provided at the asset location based on the analyzing of the asset location data. Further, the processing device 1204 may be configured for performing a step of generating the lifestyle index for the real estate asset based on the determining of the level of the at least one facility provided at the asset location.

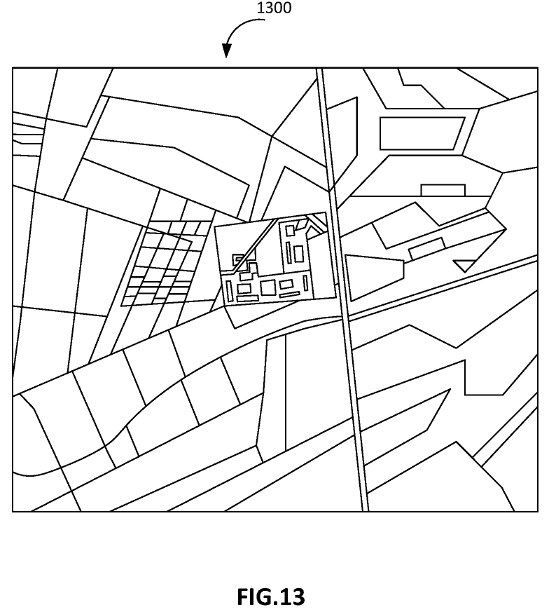

FIG. 13 is a schematic diagram of an area map 1300 of an area associated with a real estate asset, in accordance with some embodiments. Further, the area map 1300 may include legal information associated with the real estate asset, civic infrastructure information of civic infrastructures present in the area, future planned development information of future planned developments in the area, price information associated with prices of the real estate, construction information associated with constructions in the real estate asset, project history information associated with a project history of the real estate asset, builder profile information associated with a builder profile of a builder associated with the real estate asset, and watch outs information associated with watch outs of the area. Further, the legal information may include a land acquisition status, license chronology, environment clearances, etc. Further, the civic infrastructures information roads and connectivity, sewage and pipelines, electricity and utilities, etc. Further, the future planned development information may include master plan information, metro and other connectivity, business hubs, malls and shopping, etc. Further, the price information may include real time market price, builder prices, special schemes, etc. Further, the construction information may include tower wise construction status, place of construction, quality of construction, etc. Further, the project history information may include launch data, major events and price triggers, major flags +ve and -ve, etc. Further, the builder profile information past projects delivery, in pipeline projects, creditworthiness and financial strength, etc. Further, the watch outs information may include adjoining villages, slum, drains, STPs, under construction zones, etc.

Although the present disclosure has been explained in relation to its preferred embodiment, it is to be understood that many other possible modifications and variations can be made without departing from the spirit and scope of the disclosure.

We claim:

1. A method for facilitating predicting a future value of real estate assets, the method comprising:
receiving, using a communication device, at least one real estate asset indication of a real estate asset from at least one user device;
identifying, using a processing device, an asset location of the real estate asset based on the at least one real estate asset indication;
retrieving, using a storage device, price information of the real estate asset from a distributed ledger based on the identifying, wherein the price information comprises a price trend of a price of the real estate asset;
retrieving, using the storage device, one or more indexes associated with the asset location from the distributed ledger based on the identifying, wherein the price corresponds to the one or more indexes, wherein the one or more indexes comprises a livability index, a commercial proximity index, a lifestyle index, and a value-for-money index;
analyzing, using the processing device, the price trend and the one or more indexes based on at least one machine learning model;
establishing, using the processing device, a correlation between the price trend and the one or more indexes based on the analyzing;
generating, using the processing device, the future value for the real estate asset at a future time based on the correlation, the price trend, and the one or more indexes;
transmitting, using the communication device, the future value of the real estate asset to the at least one user device; and
storing, using the storage device, one or more datasets to the distributed ledger, wherein the one or more datasets comprises at least one of the one or more indexes and the price information.

2. The method of claim 1 further comprising:
identifying, using the processing device, at least one monitoring device associated with the asset location based on the identifying of the asset location, wherein the at least one monitoring device is configured for generating at least one environmental quality index for the asset location based on monitoring at least one of an environmental condition and an environment medium of an environment of the asset location;
generating, using the processing device, at least one request for the at least one monitoring device based on the identifying of the at least one monitoring device;
transmitting, using the communication device, the at least one request to the at least one monitoring device;
receiving, using the communication device, the at least one environmental quality index from the at least one monitoring device;
analyzing, using the processing device, the price trend and the at least one environmental quality index based on the at least one machine learning model, wherein the price corresponds to the at least one environmental quality index; and
establishing, using the processing device, a primary correlation between the price trend and the at least one environmental quality index based on the analyzing of the price trend and the at least one environmental quality index, wherein the generating of the future value is further based on the primary correlation and the at least one environmental quality index.

3. The method of claim 2, wherein the at least one monitoring device comprises at least one vehicular monitoring device traversing the asset location, wherein the monitoring of at least one of the environmental condition and the environment medium of the environment of the asset location is further based on the traversing.

4. The method of claim 2, wherein the at least one monitoring device comprises at least one satellite orbiting over the asset location, wherein the monitoring of at least one of the environmental condition and the environment medium of the environment of the asset location is further based on the orbiting.

5. The method of claim 2, wherein the at least one monitoring device comprises at least one aerial monitoring device suspending over the asset location, wherein the monitoring of at least one of the environmental condition and the environment medium of the environment of the asset location is further based on the suspending.

6. The method of claim 1 further comprising:
generating, using the processing device, an information request for the real estate asset based on the identifying of the asset location;
transmitting, using the communication device, the information request to at least one government entity device associated with at least one government entity;
receiving, using the communication device, asset information associated with the real estate asset based on the transmitting of the information request, wherein the asset information comprises at least one future project planned in at least one location around the asset location, wherein the price corresponds to the at least one future project;
analyzing, using the processing device, the price trend and the at least one future project based on the at least one machine learning model; and
establishing, using the processing device, a secondary correlation between the price trend and the at least one future project based on the analyzing of the price trend and the at least one future project, wherein the generating of the future value of the real estate is further based on the secondary correlation and the at least one future project.

7. The method of claim 6, wherein the asset information further comprises a dispute associated with the real estate asset, wherein the dispute is in connection with at least one of the real estate asset and at least one developer developing the real estate asset, wherein the price corresponds to the dispute, wherein the method further comprises:
analyzing, using the processing device, the price trend and the dispute based on the at least one machine learning model; and
establishing, using the processing device, a tertiary correlation between the price trend and the dispute based on the analyzing of the price trend and the dispute, wherein the generating of the future value of the real estate asset is further based on the tertiary correlation and the dispute.

8. The method of claim 1 further comprising:
retrieving, using the storage device, area data of an area associated with the real estate asset based on the identifying of the asset location, wherein the one or more datasets comprises the area data;
analyzing, using the processing device, the area data;
identifying, using the processing device, one or more hotspots in the area based on the analyzing of the area data;
calculating, using the processing device, one or more hotspot distances between the asset location and the one or more hotspots based on the identifying of the one or more hotspots;
retrieving, using the storage device, one or more social media data associated with the one or more hotspots based on the identifying of the one or more hotspots, wherein the one or more social media data comprises at least one social media metric indicating a popularity of the one or more hotspots;
analyzing, using the processing device, the one or more social media data using at least one machine learning algorithm, wherein the at least one machine learning algorithm is configured for determining one or more metric values of the at least one social media metric for the one or more hotspots, wherein the one or more metric values corresponds to a measurement of the popularity of the one or more hotspots;
determining, using the processing device, one or more hotspot weights of the one or more hotspots based on the one or more metric values of the at least one social media metric;
analyzing, using the processing device, the one or more hotspot distances of the one or more hotspots and the one or more hotspot weights of the one or more hotspots in relation to the real estate asset based on the determining of the one or more hotspot weights and the calculating of the one or more hotspot distances;
generating, using the processing device, the livability index for the real estate asset based on the analyzing of the one or more hotspot distances and the one or more hotspot weights; and
storing, using the storage device, the livability index to the distributed ledger.

9. The method of claim 8 further comprising:
identifying, using the processing device, one or more commercial establishments in the area based on the analyzing of the area data;
calculating, using the processing device, one or more establishment distances between the asset location and the one or more commercial establishments based on the identifying of the one or more commercial establishments;
analyzing, using the processing device, the one or more establishment distances based on the calculating of the one or more establishment distances;
generating, using the processing device, the commercial proximity index for the real estate asset based on the analyzing of the one or more establishment distances; and
storing, using the storage device, the commercial proximity index to the distributed ledger.

10. The method of claim 1 further comprising:
retrieving, using the storage device, asset location data associated with the asset location based on the identifying of the asset location;
analyzing, using the processing device, the asset location data based on the retrieving of the asset location data;
determining, using the processing device, a level of at least one facility provided at the asset location based on the analyzing of the asset location data;
generating, using the processing device, the lifestyle index for the real estate asset based on the determining of the level of the at least one facility provided at the asset location; and
storing, using the storage device, the lifestyle index to the distributed ledger.

11. A system for facilitating predicting a future value of real estate assets, the system comprising:
a communication device configured for:
receiving at least one real estate asset indication of a real estate asset from at least one user device; and
transmitting the future value of the real estate asset to the at least one user device;
a processing device communicatively coupled with the communication device, wherein the processing device is configured for:
identifying an asset location of the real estate asset based on the at least one real estate asset indication;
analyzing a price trend and one or more indexes based on at least one machine learning model;
establishing a correlation between the price trend and the one or more indexes based on the analyzing; and
generating the future value for the real estate asset at a future time based on the correlation, the price trend, and the one or more indexes; and
a storage device communicatively coupled with the processing device, wherein the storage device is configured for:
retrieving price information of the real estate asset from a distributed ledger based on the identifying, wherein the price information comprises the price trend of a price of the real estate asset;
retrieving the one or more indexes associated with the asset location from the distributed ledger based on the identifying, wherein the price corresponds to the one or more indexes, wherein the one or more indexes comprises a livability index, a commercial proximity index, a lifestyle index, and a value-for-money index; and
storing one or more datasets to the distributed ledger, wherein the one or more datasets comprises at least one of the one or more indexes and the price information.

12. The system of claim 11, wherein the processing device is further configured for:
identifying at least one monitoring device associated with the asset location based on the identifying of the asset location, wherein the at least one monitoring device is configured for generating at least one environmental quality index for the asset location based on monitoring at least one of an environmental condition and an environment medium of an environment of the asset location;
generating at least one request for the at least one monitoring device based on the identifying of the at least one monitoring device;
analyzing the price trend and the at least one environmental quality index based on the at least one machine learning model, wherein the price corresponds to the at least one environmental quality index; and
establishing a primary correlation between the price trend and the at least one environmental quality index based on the analyzing of the price trend and the at least one environmental quality index, wherein the generating of the future value is further based on the primary correlation and the at least one environmental quality index, wherein the communication device is further configured for:
transmitting the at least one request to the at least one monitoring device; and
receiving the at least one environmental quality index from the at least one monitoring device.

13. The system of claim 12, wherein the at least one monitoring device comprises at least one vehicular monitoring device traversing the asset location, wherein the monitoring of at least one of the environmental condition and the environment medium of the environment of the asset location is further based on the traversing.

14. The system of claim 12, wherein the at least one monitoring device comprises at least one satellite orbiting over the asset location, wherein the monitoring of at least one of the environmental condition and the environment medium of the environment of the asset location is further based on the orbiting.

15. The system of claim 12, wherein the at least one monitoring device comprises at least one aerial monitoring device suspending over the asset location, wherein the monitoring of at least one of the environmental condition and the environment medium of the environment of the asset location is further based on the suspending.

16. The system of claim 11, wherein the processing device is further configured for:
generating an information request for the real estate asset based on the identifying of the asset location;
analyzing the price trend and at least one future project based on the at least one machine learning model; and
establishing a secondary correlation between the price trend and the at least one future project based on the analyzing of the price trend and the at least one future project, wherein the generating of the future value of the real estate is further based on the secondary correlation and the at least one future project, wherein the communication device is further configured for:
transmitting the information request to at least one government entity device associated with at least one government entity; and
receiving asset information associated with the real estate asset based on the transmitting of the information request, wherein the asset information comprises the at least one future project planned in at least one location around the asset location, wherein the price corresponds to the at least one future project.

17. The system of claim 16, wherein the asset information further comprises a dispute associated with the real estate asset, wherein the dispute is in connection with at least one of the real estate asset and at least one developer developing the real estate asset, wherein the price corresponds to the dispute, wherein the processing device is further configured for:
analyzing the price trend and the dispute based on the at least one machine learning model; and
establishing a tertiary correlation between the price trend and the dispute based on the analyzing of the price trend and the dispute, wherein the generating of the future value of the real estate asset is further based on the tertiary correlation and the dispute.

18. The system of claim 11, wherein the storage device is further configured for:
retrieving area data of an area associated with the real estate asset based on the identifying of the asset location, wherein the one or more datasets comprises the area data;
retrieving one or more social media data associated with one or more hotspots based on the identifying of the one or more hotspots, wherein the one or more social media data comprises at least one social media metric indicating a popularity of the one or more hotspots; and
storing the livability index to the distributed ledger, wherein the processing device is further configured for:
analyzing the area data;
identifying the one or more hotspots in the area based on the analyzing of the area data;
calculating one or more hotspot distances between the asset location and the one or more hotspots based on the identifying of the one or more hotspots;
analyzing the one or more social media data using at least one machine learning algorithm, wherein the at least one machine learning algorithm is configured for determining one or more metric values of the at least one social media metric for the one or more hotspots, wherein the one or more metric values corresponds to a measurement of the popularity of the one or more hotspots;
determining one or more hotspot weights of the one or more hotspots based on the one or more metric values of the at least one social media metric;
analyzing the one or more hotspot distances of the one or more hotspots and the one or more hotspot weights of the one or more hotspots in relation to the real estate asset based on the determining of the one or more hotspot weights and the calculating of the one or more hotspot distances; and
generating the livability index for the real estate asset based on the analyzing of the one or more hotspot distances and the one or more hotspot weights.

19. The system of claim 18, wherein the processing device is further configured for:
identifying one or more commercial establishments in the area based on the analyzing of the area data;
calculating one or more establishment distances between the asset location and the one or more commercial establishments based on the identifying of the one or more commercial establishments;
analyzing the one or more establishment distances based on the calculating of the one or more establishment distances; and
generating the commercial proximity index for the real estate asset based on the analyzing of the one or more establishment distances, wherein the storage device is further configured for storing the commercial proximity index to the distributed ledger.

20. The system of claim 11, wherein the storage device is further configured for:
retrieving asset location data associated with the asset location based on the identifying of the asset location; and
storing the lifestyle index to the distributed ledger, wherein the processing device is further configured for:
analyzing the asset location data based on the retrieving of the asset location data;
determining a level of at least one facility provided at the asset location based on the analyzing of the asset location data; and
generating the lifestyle index for the real estate asset based on the determining of the level of the at least one facility provided at the asset location.
